(19) United States
(12) Patent Application Publication
(10) Pub. No.: US 2014/0079404 A1
(43) Pub. Date: Mar. 20, 2014

(54) METHOD AND SYSTEM FOR FREE SPACE OPTICAL COMMUNICATION UTILIZING A MODULATED ELECTRO-OPTICAL POLYMER RETRO-REFLECTOR

(71) Applicant: UNIPIXEL DISPLAYS, INC, The Woodlands, TX (US)

(72) Inventor: Martin A. Kykta, The Woodlands, TX (US)

(73) Assignee: UNIPIXEL DISPLAYS, INC., The Woodlands, TX (US)

(21) Appl. No.: 13/980,251

(22) PCT Filed: Jan. 29, 2013
(86) PCT No.: PCT/US13/23616

§ 371 Date: Jul. 17, 2013

Related U.S. Application Data
(60) Provisional application No. 61/592,407, filed on Jan. 30, 2012.

(51) Int. Cl. H04B 10/11

(52) U.S. Cl. CPC H04B 10/11
USPC 398/128

(57) ABSTRACT

A free space optical communication system (FSOCS) comprising a modulating retro-reflector (MRR) to receive an interrogation beam from a transceiver, and to modulate and reflect the interrogation beam. The MRR comprising a transmissive electro-optical polymer (EOP) modulator, a signal generator, and a retro-reflector, wherein the transmissive EOP modulator is to modulate the interrogation beam's polarization, the signal generator is operatively coupled to the EOP modulator and is to supply the modulation signal, and the retro-reflector is to reflect a modulated beam back towards the transceiver.

### CROSS-REFERENCE TO RELATED APPLICATION

The present application claims priority to U.S. Provisional Patent Application No. 61/592,407, filed on Jan. 30, 2012 (Attorney Docket No. 2911-03300); which is hereby incorporated herein by reference.

### BACKGROUND

This invention relates generally to the field of free space optical communication systems (FSOCS), specifically to a modulated retro-reflector device that can be used in a FSOCS.

Free space optics (FSO) or optical wireless is a telecommunication technology that uses light propagating in free space to transmit data between two points. It is a line of sight communication technology that uses optical pulse modulated signals to wirelessly transmit data. Instead of the pulses of light being contained within a glass fiber, they are transmitted in a narrow beam through the atmosphere. FSO technology may be laser-based optical networking without the fiber optic cable. FSO may be based on connectivity between FSO-based optical wireless units, each unit consisting of an optical transceiver and a modulator to provide full-duplex (bi-directional) capability. Each optical wireless unit may use an optical source, plus a lens or telescope that transmits light through the atmosphere to another lens receiving the information associated with another unit.

The receiving lens or telescope may connect to a high-sensitivity receiver via an optical fiber cable. A free-space optical link may include two or more optical transceivers accurately aligned to each other with clear line-of-sight. Generally, the optical transceivers and modulators are mounted on building rooftops or behind windows. FSO transmission may be functional over distances of several hundred meters to a few kilometers.

However, current FSO communication systems may possess various drawbacks. For example, the transceiver and modulator pair of a free space optical communication system (FSOCS) may require accurate alignment. A simple FSOCS may consist of two ports separated by a distance of 10 km or less. Each port may have a transceiver and modulator. A signal light may be sent through free space from a transceiver at one location to a modulator at another location. A laser or a focused beam of light is typically used to transmit the signals. It may be difficult to cause the transmitted beam to intersect the modulator because of the distance involved, the diameter of the transmitted beam, and the diameter of the receiver. The alignment process may also be made difficult by the fact that the ports may be mounted on a tall structure such as a pole, tower or building. Wind or vibration may cause a building to sway as much as a 0.5 degrees and a tower to sway as much as 3.0 degrees. The movement of the transceiver and modulator may cause the signal connection to be broken or intermittent. To maintain the signal connection, the signal beam may be actively steered, for example using motor mounts that tilt the signal beam and an intelligent system that moves the signal beam toward the receiver to maximize the signal. Yet, active steering may increase the cost and complexity of such FSOCS pairs.

### SUMMARY

The problems noted above are solved in large part by a free space optical communication system (FSOCS) comprising a modulating retro-reflector (MRR) to receive an interrogation beam from a transceiver, and to modulate and reflect the interrogation beam. The MRR comprising a transmissive electro-optical polymer (EOP) modulator, a signal generator, and a retro-reflector, wherein the transmissive EOP modulator is to modulate the interrogation beam's polarization, the signal generator is operatively coupled to the EOP modulator and is to supply the modulation signal, and the retro-reflector is to reflect a modulated beam back towards the transceiver.

The problems may also be solved by a free space optical communication system (FSOCS) comprising a modulating retro-reflector (MRR) to receive an interrogation beam from a transceiver, and to modulate and reflect the interrogation beam. The MRR comprising a collection lens, a reflective electro-optical polymer (EOP) modulator, a signal generator, and a retro-reflector, wherein the collection lens is to collect the interrogation beam, the reflective EOP modulator is to modulate the interrogation beam by deflecting the interrogation beam in response to a modulation signal, generating a modulated beam, and the signal generator is operatively coupled to the EOP modulator and is to supply the modulation signal, and the retro-reflector is to reflect the modulated beam back towards the transceiver.

Yet another solution to the problems may be a free space optical communication system (FSOCS) comprising a modulating retro-reflector (MRR) to receive an interrogation beam from a transceiver, and to modulate and reflect the interrogation beam. The MRR comprising a reflective electro-optical polymer (EOP) modulator, a signal generator, and a retro-reflector, wherein the reflective EOP modulator is to modulate the interrogation beam by trapping the interrogation beam in response to a modulation signal, generating a modulated beam, the signal generator is operatively coupled to the EOP modulator and is to supply the modulation signal, and the retro-reflector is to reflect the modulated beam back towards the transceiver.

### BRIEF DESCRIPTION OF THE DRAWINGS

For a detailed description of example embodiments, reference will now be made to the accompanying drawings in which:

FIG. 1 shows a modulating retro-reflector (MRR) in accordance with various embodiments:

FIG. 2 shows a free space optical communication system (FSOCS) comprising a modulating retroreflector (MRR) in accordance with various embodiments; and

FIG. 3 shows another FSOCS comprising an MRR in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical or optical connection. Thus, if a first device couples to a second device, that connection may be through a direct electrical or optical connection, or through an indirect electrical or optical connection via other devices and connections.

As used herein, the term “electro-optic modulator” or “EOM” refers to an optical device in which a signal-controlled element displaying electro-optic effect may be used to modulate a beam of light. The modulation may be imposed on the phase, frequency, amplitude, or polarization of the modulated beam.

As used herein, the term “modulated retro-reflector” or “MRR” refers to a device that couples an optical retro-reflector with a modulator to reflect modulated optical signals back to an optical receiver or transceiver, allowing the MRR to function as an optical communications device without emitting its own optical power. This may allow the MRR to communicate optically over long distances without needing substantial on-board power supplies. The function of the retro-reflection component may be to direct the reflection back to or near to the source of the light. The modulation component may change the intensity or polarization of the reflection.

As used herein, the term “beam splitting polarizer” refers to a type of polarizer that may split an incident beam into two beams of differing polarizations. For example, if an incident beam comprises segments of in-plane polarization and segments of out-of-plane polarization, the beam splitting polarizer may deflect the in-plane polarization segments and allow the out-of-plane polarization segments to pass through.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A disclosed method to implement FSOCS that may not suffer from the delicate alignment requirements may comprise two sides, or sections a transceiver side to generate an interrogation beam and to receive a modulated beam, and a modulator side to modulate the interrogation beam. The interrogation beam may be an unmodulated laser beam. The modulator side may use an electro-optical polymer to impart a data signal to the interrogation beam by modulating the interrogation beam in accordance to the data signal. The modulator may also have a mirror, or retro-reflector to direct the modulated beam back toward the transceiver. The retro-reflector, possibly in conjunction with some focusing optics, may return the modulated beam to the transceiver when the interrogation beam is received within ±25 degrees off the normal of the retro-reflector. As such, active steering of the modulated or interrogation beam may not be required.

Disclosed herein are illustrative examples of an optical transceiver and a MRR for free space optical communication systems. The MRR comprises a retro-reflector, an electro-optical polymer modulator and a collection lens. The retro-reflector may be used to reflect an interrogation beam whose polarization and/or amplitude may have been changed, or modulated. The EOP's index of refraction may be changed when an electric field is applied due to the linear electro-optical effect, which may allow the modulator to change the polarization of the interrogation to create a signal that has a polarization modulation, or a modulated beam.

The transceiver may comprise a polarized laser, a beam splitting polarizer, a beam expander and a detector. The polarized laser may operate in the longer infrared wavelength range (e.g., 1550 nm) and the beam splitting polarizer may improve the polarization ratio of the outgoing laser beam and it may deflect a beam of a specific polarization onto a different path. The modulated beam may enter the beam splitting polarizer, which may split the modulated beam into two beams of differing linear polarizations, and may send one beam to the detector and the other beam back to the polarized laser. The detector may receive the modulated beam with amplitude and/or polarization modulation induced by the EOP. In accordance with various embodiments, the use of an EOP, which is placed between the collection lens and the retro-reflector, may enable fast switching (on-off keying) to create an amplitude modulation making data transmission possible.

Accordingly, several advantages of one or more aspects of this disclosure are providing a communication system that is both high-speed and possesses a high signal density while being private, since FSO communication is immune to radio frequency (RE) interference or saturation, requires no RF spectrum licensing and eliminates the need of active steering from FSOCS because the modulated retro-reflector may operate ±25 degrees without active steering. Another advantage of one or more aspects of the present disclosure is a more reliable signal free from intermittent or broken connections.

The linear electro-optic effect may occur in a birefringent material that is anisotropic (e.g., where the molecules have different symmetries for different spatial axes) which has at least two different indexes of refraction. The electro-optic effect may be observed by putting an anisotropic material between two electrodes and applying a voltage across the electrodes to generate an electric field through the anisotropic material. Then, when passing plane polarized light through the anisotropic material and perpendicular to the optic axis of the material the plane of polarization for the light may be rotated. The rotation of the polarization may be due to the change of the index of refraction of the anisotropic material along the applied electric field. The phase of the plane polarized light may change by a quarter-wave per pass through the anisotropic material while a voltage is applied.

The linear electro-optic effect may change the index of refraction proportional to the magnitude of the applied electric field. The change in the index of refraction may cause a phase shift for light waves traveling through the material. A phase shift of π/2 may cause a half-wavelength change in the polarization state of the incident light. The amount of phase shift of the polarized light also depends on the alignment of the anisotropic material between the electrodes.

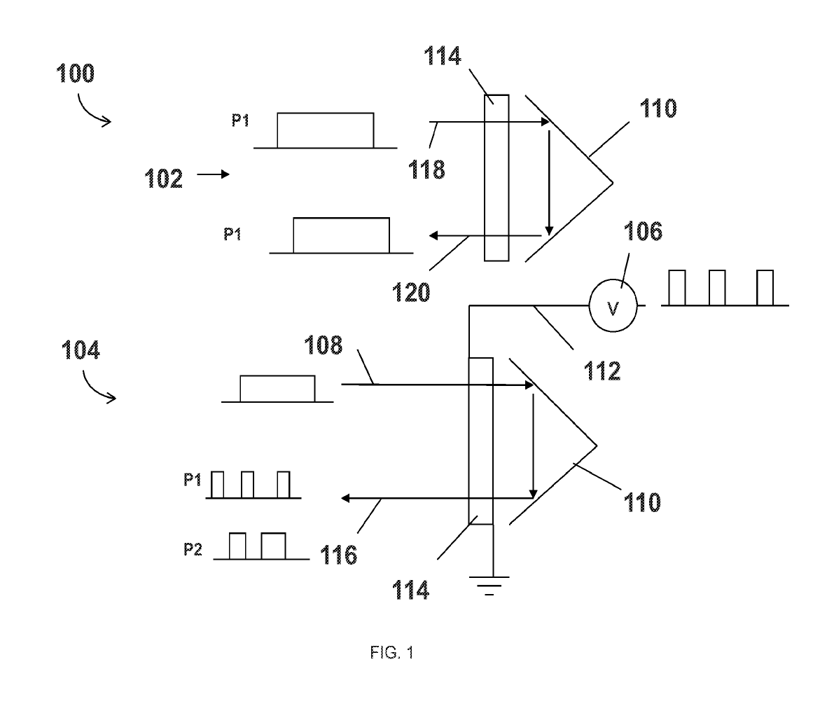

FIG. 1 shows an illustrative MRR 100 in accordance with various examples and implementing an EOP that may display the linear electro-optical effect. FIG. 1 shows two different states for the MRR 100—state 102 and state 104. The state 102 shows an interrogation beam 118, a transmissive EOP 114, a retro-reflector 110, and a reflected beam 120. The state 102 may demonstrate the behavior of the MRR 100 when the EOP 114 is in an “off” state. The EOP 114 in the off state may not affect the polarization of the interrogation beam 118 due to the index of refraction of the EOP 114 in a base state or unchanged due to no applied voltage. As such, there is no modulation of the interrogation beam 118 of polarization P1.

The state 104 comprises an interrogation beam 108, the EOP 114, the retro-reflector 110, a signal generator 106, and a modulated beam 116. The state 104 may demonstrate the behavior of the MRR 100 when the EOP 114 has a voltage applied to it, or is in an “on” state for discrete periods of time. The EOP 114 may modulate the interrogation beam when a voltage is applied. FIG. 1 shows a driver signal 106 sent to the EOP 114, which will alter the EOP 114's index of refraction during the periods the voltage is applied. In this implementation, the interrogation beam 108 is captured by a solid retro-reflector 110 after passing through the EOP 114 once, then the beam is returned back in the direction it had come into the MRR 100. A signal 112 is sent to the EOP 114, which imprints signal 112 onto the interrogation beam 108 to modulate the interrogation beam 108. The modulated beam 116, which may now be a combination of two polarization states P1 and P2, is then returned. In the MRR 100, the interrogation beam 108 may be modulated during both passes through the EOP 114—once before striking the retro-reflector 110 and once after. If the EOP 114 acts like a quarter-wave polarizer per pass, then the modulated beam 116 may be modulated by a half-wave length after passing through the EOP 114 twice.

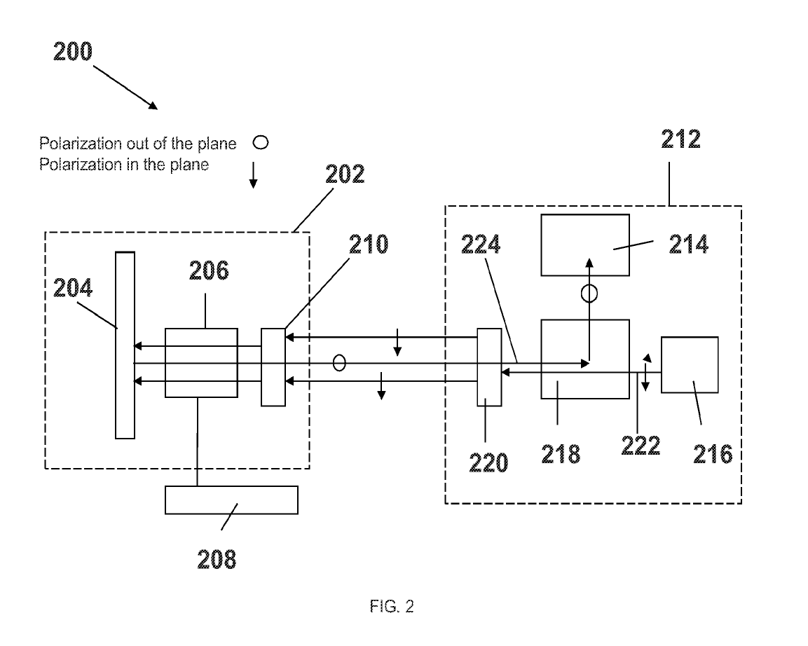

FIG. 2 shows a FSOCS 200 comprising components in accordance with various examples and implementing an MRR system, such as the MRR 100. FIG. 2 may comprise two sections—a first section may be a MRR 202 that comprises a retro-reflector 204, an EOP 206 that may be fed by a voltage signal generator 208, and collection lens 210. A second section may be a transceiver 212 that may comprise a detector 214, a polarized laser 216, a beam splitting polarizer 218, and a beam expander 220. FIG. 2 shows an interrogation beam 222 having an in-plane polarization being emitted by the polarized laser 216, passing through the beam splitting polarizer 218 and the beam expander 220. The beam expander 220 may decrease the power density of the interrogation beam 222 in order to make the FSCOS 200 comply with several eye-safety standards that apply to lasers and systems that implement lasers, such as IEC60825-1 and the North American laser safety regulation as defined by FDA/CDRH. Alternatively, a similar FSOCS may utilize circularly polarized light and appropriately placed quarter wave plates.

The MRR 202 may be located at one port (A) and may be used to transmit information to one or more ports (B, C, etc.) that may have transceivers located at them. An interrogation beam sent from ports B and C may be aimed at port A with the MRR 202. The MRR 202 at port A may modulate the interrogation beam that strikes it and may imprint a signal that may be reflected back to ports B and/or C. The retro-reflector 204 may operate over an arc of ±25 degrees without requiring active steering. This means that if the interrogation beam 222 strikes the retro-reflector 204, a modulated beam 224 may be sent back to the originating transceiver at port B and/or C as long as it is at no angle greater than 25 degrees from the normal of the retro-reflector 204.

In this embodiment, the polarized laser 216 may have an operating wavelength around 1550 nm. The 1550 nm wavelength is well suited for free space transmission due to its low attenuation when propagating through the atmosphere. Suitable sources may include very high-speed semiconductor laser technology suitable for WDM (wavelength-division multiplexing) operation as well as EDFA (erbium-doped fiber amplifier) and SOA (semiconductor optical amplifier) amplifiers used to boost transmission power. Development of WDM free space optical systems is feasible because of the attenuation properties and component availability at this range. The detector 214 may be selected for compatibility with the polarized laser 216.

Collection lens 210 may collect enough light for modulation once interrogation beam 222 is expanded by the beam expander 220 so as to have enough intensity for the return trip to the transceiver 212. Subsequently, interrogation beam 222 that intersects collection lens 210 may continue towards the retro-reflector 204. The retro-reflector 204 may be a Corner Cube Retro-reflector (CCR), or a cat's eye retro-reflector. CCRs may require a modulator, such as the EOP 206, as large as the CCR's aperture. A cat's eye retro-reflector may have large optical apertures with small (and thus fast) modulators. This embodiment is not limited to either CCRs or cat's eye retro-reflectors and either implementation may be used.

The polarization of the laser beam 222 may be changed by applying an electric field, generated by the voltage signal generator 208, to the EOP 206. If the FOP material in EOP 206 acts as a ¼ wave modulator when the signal voltage is applied, it acts as a ½ wave plate when the interrogation beam 222 makes two trips (once forward and once backward) through the EOP 206. The interrogation beam 222 polarization may be changed because two passes through the EOP 206 may cause a π/2 phase shift.

The interrogation beam 222 may be reflected back toward the transceiver 212 over a larger range of angles. The interrogation beam 222 may be reflected back towards the beam splitting polarizer 218, which may transmit or reflect the modulated beam 224 depending on its polarization. Rapidly changing the electric field generated by the voltage signal generator 208 creates the modulated beam 224 that is a combination of two different polarization states. Subsequently, the modulated beam 224 with polarization out of plane is reflected by the beam splitting cube to detector 214. Another portion the modulated beam 224 may pass through the beam splitting polarizer 218.

Alternatively, the EOP 206 may deflect the interrogation beam 222 so that the interrogation beam is not reflected by the retro-reflector 204. The deflection may occur when a voltage is applied to the EOP 206 by the voltage signal generator 208. The deflection may be due to a diffraction type grating being set up within the EOP 206, which may be a result of a periodic change in the EOP 206's index of refraction. When no voltage is applied to the EOP 206, the interrogation beam 222 may be reflected back toward the transceiver 212 by the retro-reflector 204. Implementing EOP 206 that diffracts the interrogation beam may result in a modulated beam having amplitude modulation instead of or in addition to having polarization modulation.

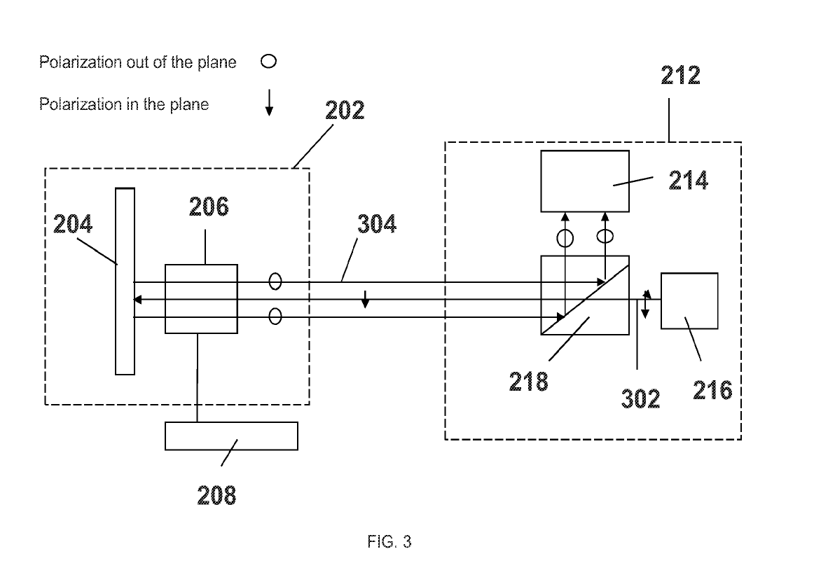

FIG. 3 shows another FSOCS 300 in accordance with various examples that may comprise some of the components of the FSOCS 200 of FIG. 2. The FSOCS 300 comprises two sections, as did the FSOCS 200. The first section may be the MRR 202 that comprises the retro-reflector 204 and EOP 206 that is fed by the voltage signal generator 208. The second section may be the transceiver 212 that comprises the detector 214, the polarized laser 216 and the beam splitting polarizer 218. Note that in FIG. 3, beam expander 220 and collection lens 210 shown in FIG. 2 have been removed. The interrogation beam 300, similar to the interrogation beam 222 described in FIG. 2, is emitted from the polarized laser 216, passes through beam splitting polarizer 218, and is aimed at the EOP 206. The EOP 206 may change the interrogation beam 302's polarization once it is reflected by the retro-reflector 204 and the interrogation beam 300 has made two trips through the EOP 206. The interrogation beam 302 may be changed to a modulated beam 304 that may have a polarization modulation similar to the modulated beam 224 of FIG. 2. The modulated beam 304 with different polarization may then reflected back to the transceiver 212 and to the detector 214 via the beam splitting polarizer 218, enabling data transmission between the transceiver 212 and the MRR 202.

Alternatively, the EOP 206 may modulated the interrogation beam 302 by absorbing or trapping the interrogation beam for an amount of time a voltage is applied to the FOP 206 by the voltage signal generator 208. In this implementation, the modulated beam 304 may be modulated by both polarization and amplitude.

What is claimed is:

1. A free space optical communication system (FSOCS), comprising:
a modulating retro-reflector (MRR) to receive an interrogation beam from a transceiver, and to modulate and reflect the interrogation beam, the MRR comprising a transmissive electro-optical polymer (EOP) modulator, a signal generator, and a retro-reflector;
wherein the transmissive EOP modulator is to modulate the interrogation beam's polarization;
wherein the signal generator is operatively coupled to the EOP modulator and is to supply the modulation signal; and
wherein the retro-reflector is to reflect a modulated beam back towards the transceiver.

2. The FSOCS of claim 1, wherein the EOP acts as a quarter-wave modulator when a voltage is applied by the signal generator.

3. The FSOCS of claim 1, wherein the interrogation beam passes through the EOP twice.

4. The FSOCS of claim 1, wherein the retro-reflector is a corner-cub retro-reflector.

5. The FSOCs of claim 1, wherein the retro-reflector is a cat's eye retro-reflector.

6. The FSOCS of claim 1, further comprising a collection lens disposed before the EOP.

7. The FSOCS of claim 1, further comprising:
a transceiver to transmit the interrogation beam and to receive the modulated beam, comprising:
a light source to generate the interrogation beam;
a beam splitter reflective to a predetermined polarization to deflect the received modulated beam; and
a detector to detect the modulated beam deflected by the beam splitter.

8. A free space optical communication system (FSOCS), comprising:
a modulating retro-reflector (MRR) to receive an interrogation beam from a transceiver, and to modulate and reflect the interrogation beam, the MRR comprising a collection lens, a reflective electro-optical polymer (EOP) modulator, a signal generator, and a retro-reflector;
wherein the collection lens is to collect the interrogation beam;
wherein the reflective EOP modulator is to modulate the interrogation beam by deflecting the interrogation beam in response to a modulation signal, generating a modulated beam;
wherein the signal generator is operatively coupled to the EOP modulator and is to supply the modulation signal; and
wherein the retro-reflector is to reflect the modulated beam back towards the transceiver.

9. The FSOCS of claim 8, wherein the reflective EOP is the retro-reflector.

10. The FSOCS of claim 8, wherein the collection lens is asphyrical.

11. The FSOCS of claim 8, wherein the reflective EOP deflects the interrogation beam away from the collection lens when a voltage is applied by the signal generator.

12. The FSOCS of claim 8, wherein the reflective EOP deflects the interrogation beam away from the collection lens when no voltage is applied by the signal generator.

13. The FSOCS of claim 8, further comprising:
a transceiver to transmit the interrogation beam and to receive the modulated beam, comprising:
a light source to generate the interrogation beam;
a beam splitter to deflect the received modulated beam; and
a detector to detect the modulated beam deflected by the beam sputter.

14. A free space optical communication system (FSOCS), comprising:
a modulating retro-reflector (MRR) to receive an interrogation beam from a transceiver, and to modulate and reflect the interrogation beam, the MRR comprising a reflective electro-optical polymer (EOP) modulator, a signal generator, and a retro-reflector;
wherein the reflective EOP modulator is to modulate the interrogation beam by trapping the interrogation beam in response to a modulation signal, generating a modulated beam; and
wherein the signal generator is operatively coupled to the EOP modulator and is to supply the modulation signal; and
wherein the retro-reflector is to reflect the modulated beam back towards the transceiver.

15. The FSOCS of claim 14, wherein the MRR further comprises a collection lens.

16. The FSOCS of claim 14, wherein the EOP is one side of a corner-cube retro reflector.

17. The FSOCS of claim 14, wherein the modulated beam is shuttered.

18. The FSOCS of claim 14, wherein EOP traps the interrogation beam when no voltage is applied by the signal generator.

19. The FSOCS of claim 14, wherein EOP traps the interrogation beam when a voltage is applied by the signal generator.

20. The FSOCS of claim 14, further comprising:
a transceiver to transmit the interrogation beam and to receive the modulated beam, comprising:
a light source to generate the interrogation beam;
a beam splitter to deflect the received modulated beam; and
a detector to detect the modulated beam deflected by the beam splitter.
